(19) United States
(12) Patent Application Publication
(10) Pub. No.: US 2010/0010710 A1
(43) Pub. Date: Jan. 14, 2010

(54) System for Influencing the Driving Behavior of a Vehicle

(75) Inventors: Johannes Kopp, Altensteig (DE); Martin Moser, Fellbach (DE); Reinhold Schneckenburger, Rutesheim (DE); Christian Urban, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG

(21) Appl. No.: 12/296,916

(22) PCT Filed: Mar. 29, 2007
(86) PCT No.: PCT/EP07/02796

§ 371 Date: May 8, 2009

(30) Foreign Application Priority Data
Apr. 13, 2006 (DE) 10 2006 017 823.8

(51) Int. Cl. G06F 19/00; B60T 8/72

(52) U.S. Cl. 701/38; 701/73

(57) ABSTRACT

A system and a device are provided for influencing the driving behavior of a vehicle by way of first and second closed-loop controls.

### BACKGROUND AND SUMMARY OF THE INVENTION

This invention relates to a method and a device for influencing the driving behavior of a vehicle.

A variety of methods and devices are known from the prior art.

German document DE 40 17 222 A1 describes a method and a system for controlling active suspension systems of a vehicle. The vehicle contains fluid suspension systems which are assigned to the respective wheels, a device for feeding a fluid into the respective fluid suspension systems and discharging it therefrom for the purpose of extending and retracting the suspension systems independently of one another, and a control device for setting the feeding devices and discharge devices for controlling the levels of the vehicle at the respective wheels. The lateral acceleration of the vehicle is sensed, and a stroke control variable is determined in response to the sensed lateral acceleration. The stroke control variable is directly proportional to the lateral acceleration. According to one embodiment, when the vehicle turns off to the left, the level of the vehicle at the right-hand front wheel is reduced by the stroke control variable, the level of the vehicle at the left-hand front wheel is raised by the stroke control variable, the level of the vehicle at the right-hand rear wheel is raised by the stroke control variable, and the level of the vehicle at the left-hand rear wheel is lowered by the stroke control variable. As a result of these measures, the load on the front outer wheel and on the rear inner wheel decreases, while the load on the rear outer wheel and on the front inner wheel increases. Overall, this reduces the degree of understeering. A corresponding procedure is adopted when the vehicle turns off to the right.

German document DE 39 43 216 C2 describes a device for controlling the drift of a vehicle on a bend. By evaluating the lateral acceleration, which is determined by means of a lateral acceleration sensor, it is detected whether the vehicle is traveling through a bend. If this is the case, a first load shift variable, which describes the shifting of the load between the front wheels, and a second load shift variable, which describes the shifting of the load between the rear wheels, is determined as a function of the steering angle and the driving force or position of the accelerator pedal. As a function of these two load shift variables, the respective pressure in suspension units which are assigned to the vehicle wheels is influenced in such a way that the fluid pressure in the suspension units on the outside of the bend of the front wheels is reduced, while, on the other hand, the fluid pressure on the inside of the bend is increased by the same absolute value. In addition, the fluid pressure on the outside of the bend of the suspension units of the rear wheels is increased by the same absolute value, while, on the other hand, the fluid pressure on the inside of the bend is reduced by the same absolute value. Overall, a yaw moment in the direction of oversteering is produced. The absolute values of the load changes of the individual wheels are the same. The load on a diagonally opposite pair of wheels increases, while the load on the other diagonally opposite pair of wheels decreases. A load shift occurs without the position of the body of the vehicle changing.

Taking the known prior art as a starting point, an object for a person skilled in the art is to develop or improve existing methods and devices for influencing the driving behavior of a vehicle to the effect, for example, that an improved driving behavior of the vehicle is produced.

This object is achieved by way of the features of the independent claims.

In the system according to the invention, for influencing the driving behavior of a vehicle, the vehicle has first closed-loop control means for performing closed-loop control on a variable which describes the yaw velocity, and second closed-loop control means for influencing wheel contact forces occurring at the vehicle wheels. The two closed-loop control means interact to the effect that, at least one closed-loop control means, a variable, which is included in the respective closed-loop control, is influenced as a function of a variable of the other closed-loop control means.

Alternatively, instead of the second closed-loop control means for influencing wheel contact forces occurring at the vehicle wheels, there may also be corresponding open-loop control means. In this case, a variable which is included in the open-loop control is then influenced as a function of a variable of the other closed-loop control means.

At the first closed-loop control means, a setpoint value for the yaw velocity is advantageously influenced as a function of a variable, which is generated in the second closed-loop control means and which represents the influencing of the wheel contact forces to be carried out by the second closed-loop control means.

As an alternative to influencing the setpoint value for the yaw velocity as a function of the variable which is generated in the second closed-loop control means and which represents the influencing of the wheel contact forces which is to be carried out by the second closed-loop control means, a variable which correlates to, or is associated with the setpoint value of the yaw velocity or a variable which is dependent thereon can also be influenced in a corresponding way. Furthermore, instead of the setpoint value, it is also possible for an actual value of the yaw velocity which is required for the closed-loop control of the variable which describes the yaw velocity to be influenced in a corresponding way, opposed to the influencing of the setpoint value. It is also conceivable to alternatively influence in a corresponding or suitable way a control error which is determined from the actual value of the yaw velocity and the setpoint value of the yaw velocity. Furthermore, it is also conceivable to alternatively perform corresponding or suitable influencing of actuator-driving variables which are determined within the scope of the closed-loop control of the variable which describes the yaw velocity for the implementation of the stabilizing interventions which are to be carried out at the individual wheel brakes and/or for the implementation of the engine interventions. It is also conceivable to alternatively influence in a corresponding way a variable which is determined during the determination of the actuator-driving variables on the basis of the actual value and the setpoint value of the yaw velocity as an intermediate variable and/or which is taken into account during this determination or included in this determination.

At the second closed-loop control means a variable which represents the influencing of the wheel contact forces which is to be carried out by the second closed-loop control means is advantageously influenced as a function of a difference variable which is determined in the first closed-loop control means and which represents a difference which is present between an actual value and the setpoint value of the yaw velocity.

In the system according to the invention for influencing the driving behavior of a vehicle, the presence of braking on a roadway is sensed with different coefficients of friction for the two sides of the vehicle. When such braking is present, a chassis which is arranged in the vehicle is tensioned diagonally at least for a certain time.

In the system for influencing the driving behavior of a vehicle, a cornering variable is determined which represents the presence of cornering of the vehicle. At least one vehicle wheel, the wheel contact force is influenced in accordance with a functional relationship as a function of the cornering variable which is determined. According to the invention, when a predetermined driving state or operating state of the vehicle is present or is reached, the functional relationship is modified, and the influencing of the wheel contact force is carried out in accordance with the modified functional relationship as a function of the cornering variable.

When a predetermined driving state or operating state of the vehicle is present or is reached, the functional relationship is modified, and the influencing of the wheel contact force is then carried out in accordance with the modified functional relationship as a function of the cornering variable, the method for influencing the driving behavior of a vehicle is adapted to certain predefined driving states or operating states of the vehicle. It is therefore possible for the method to be adapted in an optimum way to driving states and/or operating states which require a different behavior of the vehicle. Overall this results in an improvement in the behavior of the vehicle.

Both by means of the functional relationship and by means of the modified functional relationship, an associated value for the change variable is determined for a value which is respectively determined for the cornering variable.

The cornering variable is advantageously a variable which describes the lateral acceleration. In order to sense cornering, it would also be possible to use a variable which describes the yaw velocity instead of a variable which describes the lateral acceleration. However, a variable which describes the lateral acceleration has advantages over a variable which describes the yaw velocity in that the variable which describes the lateral acceleration and the lateral force which can be transmitted by the wheels are directly associated and in that the variable which describes the lateral acceleration and the slip angle that occurs at the vehicle wheels are directly associated. In contrast to this, the variable which describes the yaw velocity is dependent on the velocity. When the yaw velocity is taken into account, the velocity of the vehicle must also be taken into account. More details are given below on the advantageous relationship between the variable that describes the lateral acceleration and the lateral force.

The variable which describes the lateral acceleration can be determined in different ways. For example, this variable can be measured by means of a lateral acceleration sensor. However, this variable can also be determined as a function of a variable which describes the steering angle and a variable which describes the velocity of the vehicle. The last-mentioned procedure has the following advantage over the use of a lateral acceleration sensor: a lateral acceleration sensor is usually embodied as an inertia sensor, while a steering angle sensor is not. In addition, cornering is initiated by setting a wheel steering angle at the steered wheels. Due to the inertia of the vehicle body, this gives rise, after a delay, to a lateral acceleration which is sensed by a lateral acceleration sensor which is arranged in the vehicle. Consequently, cornering can be detected earlier in a case in which the variable which describes the lateral acceleration is determined as a function of the variable which describes the steering angle.

A vehicle usually has a left-hand front wheel and a right-hand front wheel as well as a left-hand rear wheel and a right-hand rear wheel. In this case, in each case a front wheel and a rear wheel are assigned to one of the two vehicle diagonals. For at least one of the two vehicle diagonals, the wheel contact forces at the two vehicle wheels are advantageously influenced in accordance with the functional relationship as a function of the cornering variable, wherein the wheel contact forces at these two vehicle wheels are changed in the same way. Influencing the wheel contact forces at the two vehicle wheels of a vehicle diagonal in the same way is the precondition for the level of the vehicle remaining unchanged despite a change in the wheel contact forces. Changing the wheel contact forces in the same way at the two vehicle wheels of a vehicle diagonal is to be understood as meaning the following: at these two vehicle wheels the wheel contact force is either increased simultaneously or reduced simultaneously.

In order to carry out the method according to the invention, the individual vehicle wheels are respectively assigned actuators for wheel-specific influencing of the wheel contact force occurring at the respective vehicle wheel. Wheel-specific influencing of the wheel contact force occurring at the respective vehicle wheel is to be understood as meaning the following: the actuator which is assigned to that vehicle wheel whose wheel contact force is to be influenced in a targeted fashion is driven. Of course, as a result the respective wheel contact force of those vehicle wheels with actuators that are not driven inevitably also changes to a certain degree. However, this is not intended to prevent this type of driving of the actuators which are assigned to the vehicle wheels in order to influence the wheel contact forces that are present at the vehicle wheels or occur at them from being referred to as wheel-specific influencing of wheel contact forces.

The wheel contact forces at the two vehicle wheels of the at least one vehicle diagonal are advantageously changed in the same way by virtue of the fact that the actuators of these two vehicle wheels are driven in a corresponding way. This means, for example for a case in which the wheel contact forces are to be increased at the two vehicle wheels of the at least one vehicle diagonal, that the actuators of these two vehicle wheels are driven in such a way that the wheel contact forces are increased at these two vehicle wheels. The actuators which are assigned to the two vehicle wheels of the other vehicle diagonal are not driven in this case. The same applies correspondingly to reduce the wheel contact forces. Alternatively, it is possible for the actuators of those vehicle wheels which are assigned to the other vehicle diagonal to be driven in a complementary way. This is to be understood as meaning the following: if the wheel contact forces are to be increased at the two vehicle wheels of the at least one vehicle diagonal, the actuators of the two vehicle wheels of the other vehicle diagonal are driven in such a way that the wheel contact forces at these two vehicle wheels are lowered or reduced. The actuators which are assigned to the two vehicle wheels of the at least one vehicle diagonal are not driven in this case. In order to reduce the wheel contact forces the same applies correspondingly. As an alternative to the two procedures above it is possible to adopt the following procedure: the actuators of those vehicle wheels which are assigned to the at least one vehicle diagonal and the actuators of those vehicle wheels which are assigned to the other vehicle diagonal are driven in opposing ways. This is to be understood as meaning the following: if the wheel contact forces are to be increased at the two vehicle wheels of the at least one vehicle diagonal, the actuators of the two vehicle wheels of this vehicle diagonal are driven in such a way that the wheel contact forces at these two vehicle wheels are increased. At the same time, the actuators of the two vehicle wheels of the other vehicle diagonal are driven in such a way that the wheel contact forces at these two vehicle wheels are reduced. In order to reduce the wheel contact forces the same applies correspondingly. The last-mentioned procedure has the advantage over the two procedures mentioned earlier that the driving behavior of the vehicle can be influenced more quickly since, when the two vehicle diagonals are acted on, the setting period at the individual actuators is, for example, shorter than when just one vehicle diagonal is acted on.

When cornering, the vehicle has a front wheel on the outside of the bend, a front wheel on the inside of the bend, a rear wheel on the outside of the bend, and a rear wheel on the inside of the bend. In each case a front wheel and a rear wheel are assigned to one of the two vehicle diagonals. Also, when cornering is present, for at least one of the two vehicle diagonals, the wheel contact forces at the two vehicle wheels are influenced in accordance with the functional relationship as a function of the cornering variable. In this context the procedure adopted is advantageously that the respective wheel contact force is decreased both at the front wheel on the outside of the bend and at the rear wheel on the inside of the bend. Additionally or alternatively, the respective wheel contact force is increased both at the front wheel on the inside of the bend and at the rear wheel on the outside of the bend. Overall, three actuator-driving variants are therefore possible. According to a first variant, driving is carried out only at the front wheel on the outside of the bend and at the rear wheel on the inside of the bend. According to a second variant, driving is carried out only at the front wheel on the inside of the bend and at the rear wheel on the outside of the bend. According to a third variant, the first and second actuator-driving variants are combined. If the wheel load distribution changes according to one of these three actuator-driving variants, in particular according to the third actuator-driving variant, the instantaneous center of rotation of the rotational movement of the vehicle is shifted, specifically in the direction of the center point of the bend. An oversteering yaw moment is produced. The resulting change in the rotational movement of the vehicle brings about an increase in agility and gives the driver the subjective sensation of sporty behavior. The wheel load distribution which results from the third actuator-driving variant is also referred to as diagonal or crosswise tensioning. To summarize, the chassis is tensioned diagonally or crosswise as a function of the lateral acceleration.

Within the scope of the three abovementioned actuator-driving variants, the actuators, which are respectively assigned to the individual vehicle wheels, for wheel-specific influencing of the wheel contact force occurring at the respective vehicle wheel are driven as follows: according to the first actuator-driving variant, the actuators which are respectively assigned to the front wheel on the outside of the bend and the actuators which are respectively assigned to the rear wheel on the inside of the bend are driven in such a way that the respective wheel contact force is decreased at these two vehicle wheels. According to the second actuator-driving variant, the actuators which are respectively assigned to the front wheel on the inside of the bend and the actuators which are respectively assigned to the rear wheel on the outside of the bend are driven in such a way that the respective wheel contact force is increased at these two vehicle wheels. According to the third actuator-driving variant, the actuator-driving operations of the first and second actuator-driving variants are combined.

For the two vehicle diagonals, the wheel contact forces are advantageously increased and/or decreased by the same absolute value. In particular, in the case of the third actuator-driving variant, the increase in and reduction of the wheel contact forces by the same absolute value has the advantage that despite a change in the wheel load distribution the level of the vehicle remains unchanged.

The functional relationship as a function of the cornering variable is used to determine a change variable which is a measure of the change in the wheel contact force which is to be carried out. The change variable is advantageously the value by which the wheel contact force is to be changed. Logically combining these two variables permits immediate, direct setting of the wheel load distribution, which is adapted in an optimum way to the cornering.

A setpoint value is advantageously determined for the wheel contact force which is to be set on the basis of the change variable and an actual value which is determined for the wheel contact force. As a result, a value for the wheel contact force which is to be set is determined on the basis of the wheel contact force which is respectively present and has the purpose of bringing about the desired wheel load distribution. The wheel load distribution which is required to bring about the desired driving behavior of the vehicle can therefore be set precisely.

As already stated, the vehicle wheel is assigned an actuator for wheel-specific influencing of the wheel contact force occurring at this vehicle wheel. A predefined value for the driving of the actuator is advantageously determined as a function of the setpoint value for the wheel contact force which is to be set. Depending on which variable is sensed at the actuator and is therefore available for setting the required wheel contact force, the predefined value is advantageously a setpoint value for a travel variable which is to be set with the actuator, or a setpoint value for a pressure variable which is to be set at the actuator.

The functional relationship is advantageously divided into a plurality of sections. As a result, the value of the change variable can be respectively adapted in an optimum way to the value of the cornering variable. This functional relationship is advantageously divided into four sections.

In a first section for which the cornering variable is lower than a first threshold value, the change variable assumes a first value, which essentially corresponds to the value zero. This means that the change variable assumes either the value zero or a very low value which is close to zero.

In a second section for which the cornering variable is higher than the first threshold value and lower than a second threshold value, the value of the change variable increases starting from the first value to a second value. The transition from the first section to the second section is advantageously constant. In the second section, the functional profile is rising or monotonously rising. The functional profile can have a parabolic, increasing profile. In a third section for which the cornering variable is higher than the second threshold value and lower than a third threshold value, the value of the change variable decreases starting from the second value to a third value. The transition between the second and the third section is advantageously constant. In the third section, the functional profile is falling or monotonously falling. The functional profile can have a parabolic, decreasing profile. In a fourth section for which the cornering variable is higher than the third threshold value, the value of the change variable essentially retains the third value. This can mean, for example, that the change variable retains this value in the sense of a constant. However, this can also mean that the change variable starts with the third value and decreases to a fourth value, in which case the fourth value is close to zero or corresponds to the value zero. It is also conceivable for the fourth value to be negative. As a rule, the third value is higher than the first value in absolute terms.

The predetermined driving state or operating state of the vehicle is reached or is present when the cornering variable is higher than a threshold value and at the same time a decrease in the cornering variable over time or in another vehicle variable which also represents cornering is detected. The decrease in the cornering variable over time is therefore taken into account or sensed or evaluated since the departure of the vehicle from the bend is to be sensed. In other words, it is to be detected whether the vehicle is cornering in a process in which it is leaving the bend or is in a direction changing process or in a steering back process or whether such a process has started. The steering angle which is set by the driver is evaluated, for example, as a further vehicle variable. By means of this vehicle variable it is also possible to determine whether the vehicle is in one of the abovementioned processes.

For the following reason, one of the abovementioned processes is sensed: in the case of steering back/turning back of the steering wheel out of the bend, the tensioning is not to be increased but rather reduced further. As the vehicle drives out of the bend, the driver is not to sense any increase in the “cornering-friendliness” of the vehicle. That is to say, when the vehicle drives out of the bend, the agility of the vehicle is to be increased further compared to the driving situation which was present directly before driving out of the bend. If the agility of the vehicle were to be increased further as it drives out of the bend, this would possibly confuse the driver.

The threshold value for the cornering variable is advantageously the value of the cornering variable at which the change variable has its absolute maximum in accordance with the functional relationship, or the functional relationship has its apex. This ensures that the maximum possible improvement in the agility of the vehicle can be achieved.

The modified functional relationship as a function of the cornering variable is used to determine a modified change variable which is a measure of the change in the wheel contact force which is to be carried out. In this context, the respective value of the modified change variable does not exceed, or only exceeds to an insignificant degree, the value of the change variable which was determined using the functional relationship when the predetermined driving state or operating state of the vehicle started or was present. As a result of this measure, when the vehicle is steered out of a bend its agility is not increased compared to the driving situation which was present directly before the steering out process. At any rate, a minimum increase in the agility is permitted.

The value of the change variable which was determined using the functional relationship when the predetermined driving state or operating state of the vehicle started or was present is advantageously retained as the value of the modified change variable. Alternatively, the respectively determined value of the modified change variable is lower in absolute terms than the value of the change variable which was determined using the functional relationship when the predetermined driving state or operating state of the vehicle started or was present.

The modified change variable is advantageously determined using the modified functional relationship until the value of the modified change variable corresponds to a value of the change variable which has been determined using the functional relationship and which is determined for a value of the cornering variable which is lower than the value of the cornering variable which was present when the predetermined driving state or operating state of the vehicle started or was present. This measure ensures that the value of the change variable is not determined again using the functional relationship until the value of the cornering variable is lower than the threshold value at which the change variable has its absolute maximum. A further increase in the agility or the cornering-friendliness of the vehicle is therefore avoided.

The modified functional relationship is advantageously a functional relationship which has a monotonously falling profile toward lower values of the cornering variable with respect to the value of the cornering variable and the value of the change variable which was determined for it, both values being present when the predetermined driving state or operating state of the vehicle started or was present. This ensures that there is no further increase in the agility of the vehicle. It also ensures that the agility of the vehicle is reduced since the vehicle is driving out of a bend.

A linear function with a negative gradient has proven a particularly advantageous profile. As a result of this simple mathematical relationship, the transition, described above, from the functional relationship to the modified functional relationship and back again to the functional relationship can easily be implemented.

It is possible for the value of the gradient to be permanently predefined. As a result, it is possible to implement an optimized transition, in terms of timing, from the functional relationship to the modified functional relationship. Alternatively, the value of the gradient can be determined as a function of the value of the change variable which was present when the predetermined driving state or operating state of the vehicle started or was present. This procedure permits optimum adaptation of the transition from the functional relationship to the modified functional relationship and back again to the functional relationship. In this procedure, the value of the gradient can be adapted to the transitions between the individual functional relationships in such a way that the driver is aware of, or senses, these transitions as little as possible.

In terms of determining the value of the gradient as a function of the value of the change variable which was present when the predetermined driving state or operating state of the vehicle started or was present, the following procedure is conceivable, for example: starting from said value of the change variable, a value for the change variable is determined which is to be assumed after the end of the influencing of the wheel contact forces by means of the modified functional relationship. This “final value” results from the value of the change variable through a percentage reduction or through a reduction by a fixed absolute amount. There are therefore two values for the linear function to be determined, from which values the gradient of the linear function can be determined.

Of course, it is possible, in addition to driving out of a bend, also to sense other driving states or operating states of the vehicle and to modify the functional relationship when the states are reached or are present. Additional driving-situation-dependent changes in the wheel contact forces are therefore carried out.

A further predetermined driving state or operating state of the vehicle which is to be taken into account is reached or is present when a traction control system which is arranged in the vehicle at least one driven wheel carries out interventions for performing closed-loop control on the traction present at this driven wheel during cornering. This development is significant for the case of accelerated cornering—the driver would like to accelerate again at the exit from the bend—for the following reason: given the tensioning of the vehicle already described above, the wheel contact force is increased both at the front wheel on the inside of the bend and at the rear wheel on the outside of the bend. At the same time, the wheel contact force is reduced at the front wheel on the outside of the bend and at the rear wheel on the inside of the bend. If the driver of a rear wheel drive vehicle wishes to drive quickly out of a bend, i.e. to accelerate towards the end of the cornering process—the driver requires as it were a high level of propulsion—the rear wheel on the inside of the bend which is relieved of loading can spin. Even though the rear wheel on the outside of the bend which is loaded to a greater degree as a result of the cornering can transmit a greater degree of propulsion force onto the roadway or the underlying surface, the loss of propulsion force at the rear wheel on the inside of the bend leads to a reduced acceleration capability when cornering. The development addresses this: if it is detected during cornering that the slip value at one wheel is higher than a predefined threshold value—this is mainly the case for the rear wheel on the inside of the bend—this wheel is pressed more strongly onto the underlying surface. For this purpose, the influencing of the wheel contact forces which is carried out as a function of the change variable and/or the tensioning and/or wheel load distribution which are carried out are changed. They are changed specifically in such a way that the rear wheel on the inside of the bend is again pressed more strongly onto the roadway. The presence of a slip value which is higher than a predefined threshold value can be detected, for example, by means of a flag which is generated by the traction control system and indicates that this system is carrying out interventions independently of the driver for performing closed-loop control on the traction. This flag is also referred to as a traction control system flag, since the traction control system is a system for performing closed-loop control on the traction or is a traction controller. To summarize: when drive slip occurs at the wheel which is relieved of loading, in particular at the rear wheel on the inside of the bend, the tensioning is eliminated or reduced in order to reduce the drive slip at this vehicle wheel. Alternatively or additionally to this it is possible also to brake this wheel through braking interventions which are independent of the driver.

At this point the following will be mentioned: the increase in the wheel contact force which is described above at the rear wheel on the inside of the bend because of an acceleration process occurring during cornering can also be performed without previous influencing of the wheel contact forces or wheel load distribution or tensioning which is carried out in accordance with the functional relationship as a function of the cornering variable. As a result, the wheel contact force which is reduced at the rear wheel on the inside of the bend and which results from the rolling movement caused by the cornering can be compensated.

In the driving state or operating state of the vehicle which is described above and is to be taken into account further, the value of the modified change variable is determined as follows: the value of the change variable which was determined using the functional relationship and which was present when the predetermined driving state or operating state of the vehicle started or was present is reduced by a permanently predefined value or by a value which is determined as a function of the value of the change variable. Alternatively, the value of the change variable which was determined using the functional relationship and which was present when the predetermined driving state or operating state of the vehicle started or was present is reduced until intervention for performing closed-loop control on the traction no longer occurs at the at least one driven wheel. In particular, the last-mentioned procedure permits optimum adaptation of the wheel contact force.

The wheel contact force is set in accordance with the modified change variable by means of the procedure described above at least at the at least one driven wheel at which closed-loop control on the traction is carried out. That is to say the wheel contact force is set in accordance with the modified change value at the rear wheel on the inside of the bend.

A further predetermined driving state or operating state of the vehicle which is to be taken into account is reached or is present when a braking intervention is carried out during cornering. This driving state is taken into account for the following reason: in the case of braking on a bend a sufficient lateral force has to be ensured in order to prevent the vehicle from swerving. Consequently, in this driving state or operating state of the vehicle the tensioning is reduced or eliminated. In this driving state or operating state of the vehicle it is irrelevant whether the braking which takes place during cornering is carried out by the driver or whether it is a braking intervention which is carried out independently of the driver, such as a braking intervention which can be performed, for example, by a traction control system or a vehicle movement dynamics control system with which, for example, closed-loop control is performed on the yaw velocity of the vehicle.

The value of the modified change variable is advantageously determined as follows: the value of the change variable which was determined using the functional relationship and which was present when the predetermined driving state or operating state of the vehicle started or was present is reduced by a permanently predefined value or by a value which is determined as a function of said value of the change variable.

In order to carry out the method according to the invention, the vehicle is equipped with a device which is configured correspondingly. In this context, the vehicle has determining means for determining a cornering variable which represents the presence of cornering of the vehicle, and influencing means with which, at least one vehicle wheel, the wheel contact force is influenced in accordance with a functional relationship as a function of the cornering variable. When a predetermined driving state or operating state of the vehicle is present or is reached, the functional relationship is modified, and the influencing of the wheel contact force is carried out in accordance with the modified functional relationship as a function of the cornering variable. Furthermore, the device is configured to carry out the further method steps described above.

At this point, the following will be noted with respect to the formulation “functional relationship.” Firstly, this formulation is intended to express the fact that between the cornering variable on the one hand and the wheel contact force to be influenced on the other there is, in the mathematical sense, a relationship which is brought about, for example, by the section by section assignment of the change variable to the cornering variable. However, this formulation can also be interpreted so widely that it is not only understood to mean a relationship in the mathematical sense. In a very wide interpretation it will also be understood to cover influencing possibilities, for example a change in the rules when determining the actuator-driving variables for the actuators, as a result of which influencing of the wheel contact forces is also achieved. In this case, a change to the actuator-driving variable of the actuator and not to the change variable is directly carried out, i.e. a modification of the change variable is bypassed. In this case, the change variable is converted into a setpoint value for the wheel contact force, and the wheel contact force is converted into a predefined variable or actuator-driving variable for the actuator. The predefined variable is then, however, modified or reduced. This very widely interpreted consideration applies, for example, to the acceleration process during cornering or to the case of braking on a bend.

The elimination of the tensioning mentioned in conjunction with the acceleration process during cornering or braking on a bend can be carried out, for example, by means of a time ramp.

Advantageous refinements can be found in the description and the drawing. The advantageous refinements which result from any desired combination of the subject matters described in the subclaims are also to be included.

The method and device according to the invention will be described in more detail below with reference to the drawings.

### BRIEF DESCRIPTION OF THE DRAWINGS

FIG. 1 shows the technical or physical circumstances on which the method and device according to the invention are based,

FIG. 2 shows the profile of a functional relationship which represents the dependence of a change variable on a cornering variable,

FIG. 3 shows an overview of a vehicle which is equipped with the device according to the invention in which the method according to the invention runs,

FIG. 4 shows the design of an open-loop control device according to the invention, in accordance with a first embodiment,

FIG. 5 shows the design of an open-loop control device according to the invention, in accordance with a second embodiment,

FIG. 6 shows the design of an open-loop control device according to the invention, in accordance with a third embodiment,

FIG. 7 shows the design of an open-loop control device according to the invention, in accordance with a fourth embodiment,

FIG. 8 shows the sequence of the method which runs in the device according to the invention,

FIG. 9 shows the procedure for determining the change variable in conjunction with steering out of a bend, and

FIG. 10 shows the procedure for the diagonal tensioning of the chassis when predetermined driving states or operating states of the vehicle are present.

### DETAILED DESCRIPTION OF THE INVENTION

Components which are contained in different drawings and which are provided with the same reference signs have the same operation.

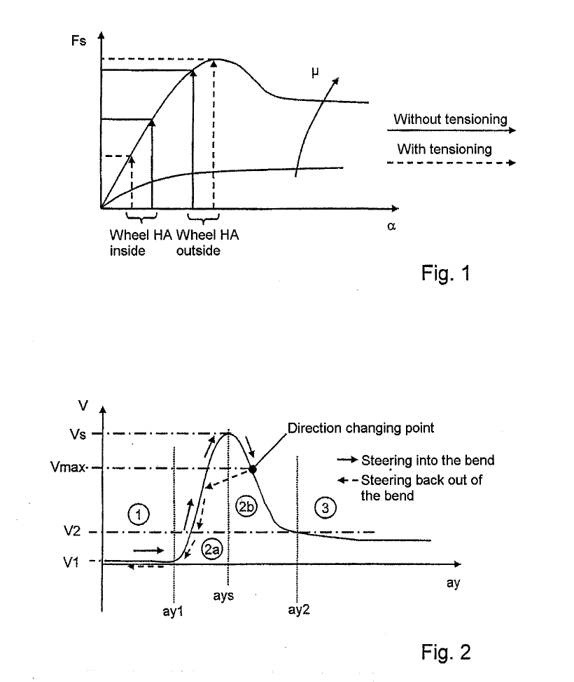

In FIG. 1, the relationship for the two variables of the slip angle α and wheel lateral force or lateral force Fs which occur at a vehicle wheel is illustrated schematically. It is indicated here that a group of curves is produced as a function of the coefficient of friction present between the tire of the vehicle wheel and the surface of the roadway. The slip angle is the angle between the plane of the rim and the direction of movement of the vehicle wheel. As is apparent from the illustrated curve profile, in the case of a large coefficient of friction there is, in a first section, a linear relationship between the lateral force and the slip angle which changes into a nonlinear relationship in the vicinity of the maximum. For the region in which there is the linear relationship between the slip angle and the lateral force, there is a linear relationship between the slip angle and the lateral acceleration acting on the vehicle during cornering. Consequently, the lateral acceleration is a measure or an estimate of the slip angle, knowledge of which therefore makes it possible to determine whether the respective vehicle wheel is in the linear region or in the nonlinear region. It is therefore possible to use the lateral acceleration as a cornering variable, as a function of which the wheel contact force is influenced in accordance with a functional relationship at least one vehicle wheel.

The knowledge as to whether the vehicle wheel is in the linear or nonlinear region is important for the following reason: in FIG. 1 the lateral forces occurring at the two rear wheels during cornering are illustrated by means of unbroken arrows and lines (illustration “without tensioning”). Because of the load shift occurring during cornering toward the wheels on the outside of the bend, the rear wheel on the outside of the bend has a higher lateral force than the rear wheel on the inside of the bend. The rear wheel on the inside of the bend is in the linear region, while the rear wheel on the outside of the bend is in the nonlinear region. If the chassis is then tensioned according to the invention, i.e. the wheel contact force is reduced both at the front wheel on the outside of the bend and at the rear wheel on the inside of the bend, and the wheel contact force is increased both at the front wheel on the inside of the bend and at the rear wheel on the outside of the bend—the individual wheel contact forces being increased or decreased by the same absolute value—the changes in the lateral forces which are illustrated in FIG. 1 (illustration “with tensioning”) are brought about for the rear axle. At the rear wheel on the inside of the bend, the lateral force decreases by a larger absolute value than the increase in the lateral force at the rear wheel on the outside of the bend. This leads to a situation in which the sum of the lateral forces or wheel lateral forces at the rear axle decreases overall as a result of the tensioning. A corresponding observation for the front axle means that as a result of the tensioning according to the invention the sum of the lateral forces or wheel lateral forces at the front axle increases overall as a result of the tensioning. As a result of this change in the lateral forces at the front axle and at the rear axle, an oversteering yaw moment is produced and the vehicle therefore behaves in a more agile fashion during cornering. The observation above therefore indicates that the driving behavior can be influenced by tensioning only if one of the two vehicle wheels of a vehicle axle is in the nonlinear region or in the vicinity of the nonlinear region. In the case of a high coefficient of friction it is not possible to exert any effect on the driving behavior by means of the tensioning in the region of small slip angles owing to the linearity of the curve illustrated in FIG. 1: the wheel lateral force which is acquired at the rear wheel on the outside of the bend is lost again at the rear wheel on the inside of the bend, with the result that the balance of the lateral forces at the rear axle is unchanged. The vehicle behaves the same at the front axle. The lateral acceleration remains essentially the same at the two vehicle axles because of the unchanged sum of lateral forces. Only if the slip angle of the wheel on the outside of the bend reaches the nonlinear region of the curve or moves back into this region as a result of the tensioning is a change brought about in the cornering behavior since the sum of the wheel lateral forces at the vehicle axle changes. In the case of a low coefficient of friction, although the curve is already nonlinear even at low slip angles, the sum of the transmitted lateral forces at an axle will in fact not be reduced at low coefficients of friction. For this reason, care must be taken to ensure that when a low coefficient of friction is present the chassis is not tensioned, or is at most tensioned only to a very small degree.

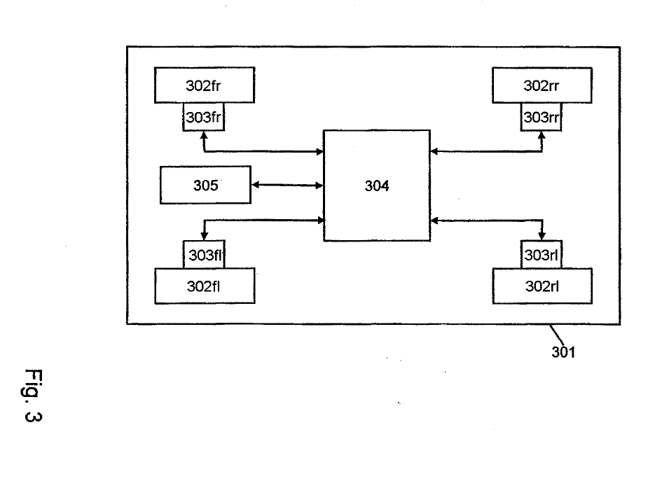

The profile which is illustrated in FIG. 2 for the functional relationship between the cornering variable ay and the change variable V can be derived from the considerations above. This profile is divided into four sections. In a first section (marked by 1 in FIG. 2) for which the cornering variable ay is lower than a first threshold value ay1, the change variable V assumes a first value V1 which corresponds essentially to the value zero. In this first section, i.e. at low lateral acceleration values, the chassis is not to be tensioned, or is to be tensioned only to an insignificant degree, since in this lateral acceleration region, it is not possible to achieve a significant effect by tensioning the chassis—this applies to a case with a high coefficient of friction—or a reduction in the sum of the wheel lateral forces at an axle is to be avoided—this applies to a case with a low coefficient of friction. In a second section (marked by 2a in FIG. 2) for which the cornering variable ay is higher than the first threshold value ay1 and lower than a second threshold value ays, the value of the change variable V increases starting from the first value V1 to a second value Vs. That is to say up to the apex of the functional relationship, which is at ays, the tensioning of the chassis is increased, i.e. the wheel contact forces at the rear wheel on the outside of the bend and at the front wheel on the inside of the bend are increased continuously, and at the same time the wheel contact forces at the front wheel on the outside of the bend and at the rear wheel on the inside of the bend are reduced continuously, up to said apex, as a result of which the cornering-friendliness or agility of the vehicle increases continuously starting from the value ay1 of the cornering variable to the value ays of the cornering variable. In a third section (marked by 2b in FIG. 2) for which the cornering variable ay is higher than the second threshold value ays and lower than a third threshold value ay2, the value of the change variable V decreases starting from the second value Vs to a third value V2. That is to say starting from the apex of the functional relationship there is a decrease in the tensioning in order to increase again the maximum possible lateral acceleration by increasing the sum of all the wheel contact forces. In a fourth section (marked by 3 in FIG. 2) for which the cornering variable ay is higher than the third threshold value ay2, the value of the change variable V essentially retains the third value V2. Consequently, in this section the tensioning is essentially retained unchanged. In contrast to what is illustrated in FIG. 2, the value of the change variable can also decrease to zero or to a value less than zero since at very high lateral acceleration values the sum of the wheel lateral forces at an axle is not to be decreased.

Details will be given once more on the third section. In this third section, what is referred to as a “direction changing point” is marked on the functional relationship. This direction changing point characterizes a predetermined driving state or operating state of the vehicle. Up to this direction changing point, the cornering variable ay increases continuously, i.e. the vehicle is steering into a bend and is then cornering (illustration “steering into the bend”). Once the direction changing point is reached, the process of driving out of the bend or the steering back process or direction changing process begins. The vehicle is steered back out of the bend (illustration “steering back out of the bend”) and the cornering variable therefore decreases. For the direction changing point shown in FIG. 2, the apex of the functional relationship is already exceeded. If the profile of the functional relationship were then followed in accordance with the decreasing cornering variable, the value of the change variable would increase again and therefore the tensioning of the chassis would also increase and the vehicle would exhibit increasing cornering-friendliness or agility. This is to be avoided particularly when steering back or turning back the steering wheel out of the bend, and the tensioning of the chassis is not to be increased but rather only reduced so that the driver does not sense any increase in the “cornering-friendliness” as the vehicle drives out of the bend. In order to achieve this, the functional relationship is not followed when the vehicle is steered back out of the bend. The functional relationship which applies until then is, as it were, replaced by a modified functional relationship. The modified functional relationship is used to determine a modified change variable Vm as a function of the cornering variable ay, and the wheel contact force is influenced in accordance with the modified functional relationship as a function of the cornering variable. The modified functional relationship is retained until the value of the modified change variable which is determined by means of the modified functional relationship as a function of the cornering variable corresponds to the value of the change variable which is determined by means of the functional relationship as a function of the cornering variable.

As is apparent from the statements above, the predetermined driving state or operating state of the vehicle is reached or is present when the cornering variable ay is higher than a threshold value ays and at the same time a decrease in the cornering variable over time—the time gradient of the cornering variable is negative—is detected. As an alternative to the decrease in the cornering variable, the decrease in another vehicle variable, which also represents cornering, can also be sensed or evaluated. For example the steering angle which is set by the driver is possible as a further vehicle variable.

The change variable V represents a difference between the wheel contact forces of the two vehicle wheels of a vehicle axle. Starting from the actual value of the wheel contact force which is sensed for the respective vehicle wheels, it is conceivable, for the purpose of diagonal tensioning of the chassis, to decrease the wheel contact force at the front wheel on the outside of the bend and at the rear wheel on the inside of the bend by the value of the change variable and at the same time to increase the wheel contact force at the front wheel on the inside of the bend and at the rear wheel on the outside of the bend by the value of the change variable. Alternatively it is conceivable for the increase or decrease at the individual vehicle wheels to be respectively only half the value of the change variable.

The functional relationship is used to determine a change variable as a function of the cornering variable. The profile of the functional relationship is illustrated in FIG. 2. Various procedures for determining the associated value of the change variable on the basis of a value of the cornering variable in an open-loop control device which is contained in the vehicle are conceivable. It is possible, for example, to store a table in this open-loop control device, which table contains, in a way which models the profile illustrated in FIG. 2, the associated value of the change variable for a plurality of values of the cornering variable. However it is also conceivable to store in the open-loop control device a mathematical function which is composed of a plurality of polynomial functions and is modeled on the profile illustrated in FIG. 2. This mathematical function can be used to calculate the value of the change variable from the value of the cornering variable.

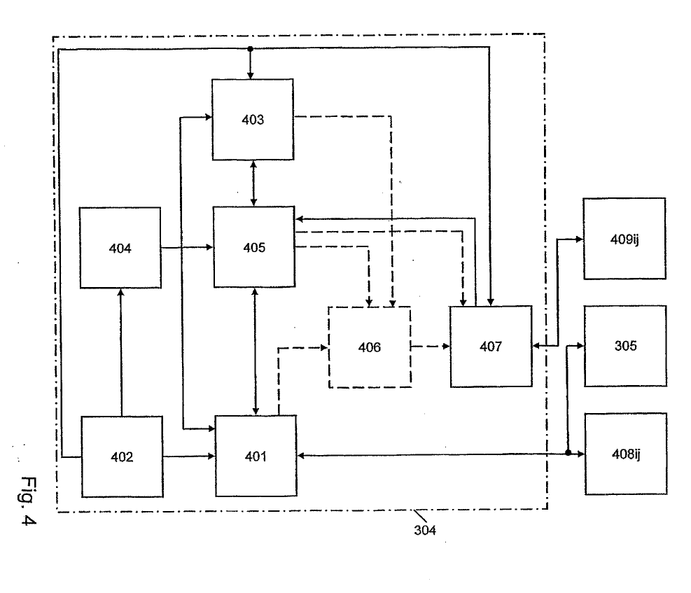

FIG. 3 illustrates in schematic form a vehicle 301 which is equipped with a device according to the invention in which the method according to the invention runs. The vehicle has vehicle wheels 302ij, the index i denoting whether the vehicle wheel is a front vehicle wheel (f) or a rear vehicle wheel (r), and the index j denoting whether the vehicle wheel is a left-hand vehicle wheel (l) or a right-hand vehicle wheel (r). If this nomenclature is used for other components it has the same meaning there. The individual vehicle wheels 302ij are respectively assigned actuators 303ij. These actuators comprise, as is explained further below, at least means for generating a braking force and means for influencing the wheel contact force. In addition, the vehicle 301 contains an open-loop control device 304 with which actuator-driving variables or open-loop control signals are generated for the actuators 303ij, and a block 305. The block 305 will comprise an engine, arranged in the vehicle, together with influencing means with which the engine torque which is output by this engine can be influenced. As illustrated in FIG. 3, variables for processing can also be fed to the open-loop control device 304 from the actuators 303ij and the block 305. The device according to the invention is composed of the open-loop control device 304 and at least some of the actuators 303ij. At this point it is to be noted that the use of the term open-loop control device is not intended to have a restrictive effect in terms of the generation of the actuator-driving variables or open-loop control signals which are output by the open-loop control device. These variables and signals can be generated within the scope of a closed-loop control process or in the scope of an open-loop control process.

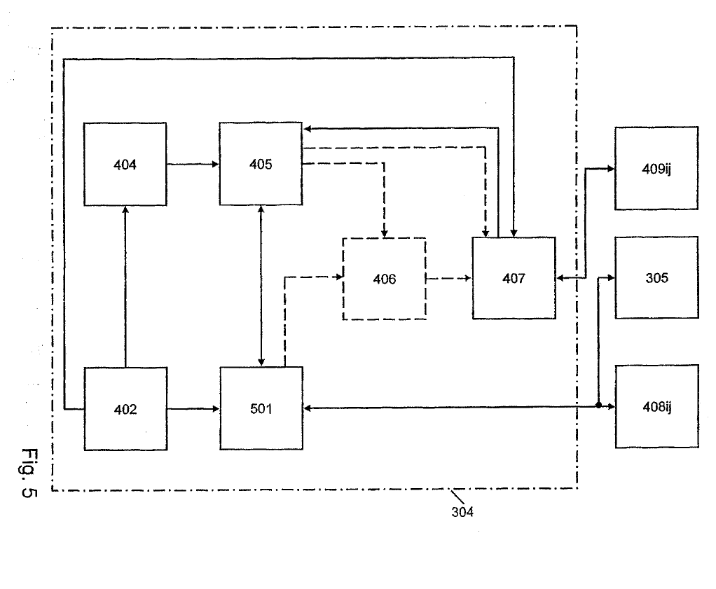

FIG. 4 shows the design of the open-loop control device 304 according to the invention in accordance with a first embodiment. The open-loop control device 304 comprises a block 401 which is a vehicle movement dynamics controller. This vehicle movement dynamics controller 401 is supplied with various sensor signals from a block 402 which comprises various sensor means contained in the vehicle. Actuator-driving variables or open-loop control signals for driving actuators contained in the vehicle are generated in the vehicle movement dynamics controller 401 as a function of these sensor signals. These actuators are illustrated in FIG. 4 by means of the blocks 305 and 408ij.

The vehicle movement dynamics controller 401 comprises various functionalities. On the one hand, the vehicle movement dynamics controller 401 comprises the functionality of a brake slip controller with which closed-loop control is performed on the brake slip occurring at the vehicle wheels 302ij during a braking process. For this purpose, wheel speed variables, which represent the wheel speeds present at the individual vehicle wheels 302ij, are fed to the vehicle movement dynamics controller 401 from the block 402 which comprises wheel speed sensors which are assigned to the individual vehicle wheels 302ij. In a known fashion, actuator-driving variables or open-loop control signals, which are fed to individual brake actuators 408ij which are assigned to the respective vehicle wheels 302ij for the purpose of performing closed-loop control on the brake slip, are determined from these wheel speed variables in the vehicle movement dynamics controller 401. On the other hand, the vehicle movement dynamics controller 401 also comprises the functionality of a traction controller with which closed-loop control is performed on the traction occurring at the vehicle wheels during an acceleration process. For this purpose, corresponding sensor signals are fed to the vehicle movement dynamics controller 401 from the block 402. The sensor signals are said wheel speed variables and an engine speed variable which is made available by a sensor for sensing the rotational speed of the vehicle engine contained in the block 305. Actuator-driving variables and/or open-loop control signals, which are fed to the brake actuators 408ij and to the block 305 for the purpose of performing closed-loop control on the traction, are generated in a known fashion from these signals in the vehicle movement dynamics controller 401. In the block 305, the influencing means for reducing the engine torque which is output by the vehicle engine are driven by the actuator-driving variables or open-loop control signals.

Furthermore, the vehicle movement dynamics controller 401 also generates actuator-driving variables and/or open-loop control signals for the brake actuators 408ij and the block 305 for the purpose of performing closed-loop control on the yaw velocity of the vehicle. Within the scope of this functionality, the vehicle movement dynamics controller 401 generates actuator-driving variables and/or open-loop control signals for the brake actuators 408ij for the purpose of carrying out wheel-specific braking interventions which are independent of the driver and with which a yaw moment which acts on the vehicle can be generated. If necessary, the vehicle movement dynamics controller 401 also generates actuator-driving variables and/or open-loop control signals which are fed to the block 305 and by means of which the influencing means for reducing the engine torque which is output by the vehicle engine are driven. In order to implement this functionality, the block 401 receives, from the block 402, a lateral acceleration variable, a steering angle variable, wheel speed variables and an admission pressure variable which represents the brake pressure set by the driver. Consequently, the block 402 comprises corresponding sensor means. In order to be able to generate the abovementioned actuator-driving variables and open-loop control signals for performing closed-loop control on the yaw velocity, the vehicle movement dynamics controller 401 also requires information which characterizes a difference which is possibly present between an actual value determined for the yaw velocity and a setpoint value which is predefined for said yaw velocity. This information is fed to the vehicle movement dynamics controller 401 from a block 403 which is a yaw velocity controller. In order to be able to make this information available, a yaw velocity variable, a steering angle variable and wheel speed variables are fed to the block 403 from the block 402, which comprises corresponding sensor means. A mathematical model is used to determine a setpoint value for the yaw velocity in the block 403 as a function of the steering angle variable and a vehicle velocity variable, which is determined in the block 403 on the basis of the wheel speed variables. A difference which is possibly present between the actual value and the setpoint value for the yaw velocity is determined, for example, by forming differentials. The differential variable which is obtained in this way can be fed to the block 401. However, it is also conceivable for a difference which is present for the yaw velocity between the actual value and the setpoint value to be converted in the block 403 into setpoint slip change variables for the individual vehicle wheels 302ij, and for these to then be fed to the block 401. A lateral acceleration variable is fed to a block 404 from the block 402. In the block 404, the derivative of this lateral acceleration variable over time is formed, and that derivative is fed together with the lateral acceleration variable to a block 405. In the block 405, a change variable V is determined in accordance with the functional relationship illustrated in FIG. 2, as a function of the lateral acceleration variable, which is the cornering variable, and the derivative of the lateral acceleration variable over time.

Setpoint values Fnsollij for wheel contact forces which are to be set at the individual vehicle wheels 302ij are determined in the block 405 on the basis of the change variable V and actual values Fnistij for the wheel contact forces which are present at the individual vehicle wheels 302ij. These setpoint values are fed to a block 407, which is a ride control system. More details will be given below on the dot-dash representation used in this context in FIG. 4. The actual values Fnistij of the wheel contact forces which are required in the block 405 are fed to the block 405 from the ride control system 407. The actual values of the wheel contact forces are determined in the ride control system 407 for example as a function of the variables fed to it and using suitable models.

The ride control system 407 is part of an active suspension system which is contained in the vehicle and which contains, in addition to the ride control system 407, corresponding sensor means as further components which are to be included in the block 402, and actuators 409ij which are assigned to the individual vehicle wheels 302ij and have the purpose of wheel-specific influencing of the wheel contact force occurring at the respective vehicle wheel 302ij.

The active suspension system controls the movements of the body of the vehicle 301 using additional wheel contact forces which are generated at the individual vehicle wheels 302ij by means of the actuators 409ij. The actuators 409ij are active suspension struts which are assigned to the respective vehicle wheels 302ij and in which the spring and shock absorber are, for example, connected in parallel. In such an active suspension strut, the helical spring is supported with respect to the vehicle wheel 302ij on a spring plate which is permanently connected to the shock absorber tube, and with respect to the vehicle body on a spring plate which is connected to a single-action hydraulic cylinder. By hydraulically actuating this hydraulic cylinder or adjustment cylinder the latter is moved and the pretensioning of the helical spring is therefore increased or reduced.

As a result, the wheel contact force at the respective vehicle wheel 302ij can be influenced. By actuating the adjustment cylinders, the spring base point is therefore adjusted. As an alternative to the statements above, the active suspension struts can also be embodied as what are referred to as hydro-pneumatic springs.

The actuators 409ij are driven by means of corresponding actuator-driving variables or open-loop control signals as a function of the current state of the vehicle 301 from the ride control system 407. The ride control system 407 is informed about the current state of the vehicle 301 by means of sensor signals which are fed to it from the block 402. These sensor signals are sensor signals which represent the movement state of the body of the vehicle 301, sensor signals which represent the current vehicle ride level with respect to the roadway, and sensor signals which represent the respective current actuation states of the active suspension struts, to be more precise the respective current position of the adjustment cylinders. The sensor signals which represent the movement state of the body of the vehicle 301 are, for example, three vertical acceleration variables which describe the vertical acceleration present at three different locations on the vehicle body, a lateral acceleration variable which describes the lateral forces acting on the vehicle, and a longitudinal acceleration variable which describes the acceleration or deceleration of the vehicle. These acceleration variables are sensed by corresponding acceleration sensors which are arranged on the vehicle 301. The sensor signals which represent the current vehicle ride level with respect to the roadway are sensed using ride level sensors which are assigned to the individual vehicle wheels 302ij. These ride level sensors are used to sense the respective relative travel between the vehicle body and the wheel center point. From the relative travel values sensed for the vehicle wheels 302ij it is possible to determine the vehicle ride level. The sensor signals which represent the respective current actuation states of the active suspension struts are, for example, variables which are made available by travel sensors which sense the adjustment travel of the adjustment cylinder, or variables which are made available by pressure sensors which sense the hydraulic pressure which has been set in the adjustment cylinder. Block 402 is intended to comprise the abovementioned sensor means which are associated with the active suspension system. The actuator-driving variables or open-loop control signals which are output by the ride control system 407 to the actuators 409ij represent the adjustment travel or the hydraulic pressure depending on which variable of the adjustment cylinder is influenced in accordance with the closed-loop control concept implemented in the ride control system 407.

The active suspension system compensates dynamic vehicle body movements such as vertical reciprocating movements or pitching movements or rolling movements. Furthermore, the active suspension system permits load-dependent adjustment of the ride levels at the front axle and at the rear axle. For this purpose, various algorithms are implemented in the ride control system 407. What is referred to as a skyhook algorithm minimizes the absolute acceleration value of the body of the vehicle 301 by means of the three vertical acceleration variables independently of the excitation by the roadway. An Aktakon algorithm processes the relative travel values between the vehicle body and the individual vehicle wheels 302i. A comparison between the actual value and setpoint value for the relative travel permits the vehicle to be placed at a specific ride level or to be kept at that level. The suspension behavior of the vehicle 301 is influenced at the same time. The rolling of the vehicle body during dynamic steering maneuvers is reduced by means of a lateral acceleration application process. The pitching during braking processes or acceleration processes is reduced by means of a longitudinal acceleration application process. The setpoint values Fnsollij which are supplied by the block 405 for the wheel contact forces can be included, for example, in the Aktakon algorithm or in the lateral acceleration application process and are therefore taken into account in the driving of the actuators 409ij.

Details will now be given on the dot-dash representation in FIG. 4. The dot-dash representation expresses the fact that a plurality of alternatives for making available setpoint values Fnsollij for the wheel contact forces are conceivable. According to a first alternative, setpoint values for the wheel contact forces are determined only by the block 405 and are then fed to the ride control system 407. According to a second alternative, setpoint values Fnsollij for the wheel contact forces are not only determined by the block 405 but also by the block 401 and/or the block 403. In this alternative, the setpoint values Fnsollij which are determined for the wheel contact forces by the block 405 and the setpoint values Fnsollij which are determined for the wheel contact forces by the block 401 and/or 403 are not fed directly to the ride control system 407 but rather to a block 406. The block 406 is a coordination means. The coordination means combines the setpoint values Fnsollij which are generated by the blocks 401, 403 and 405 for the wheel contact forces to form a uniform setpoint value for the respective vehicle wheels 302ij. This can be done, for example, by weighted addition, prioritized selection or by other suitable procedures.

In the block 403, the determination of setpoint values Fnsollij for the wheel contact forces can be carried out, for example, according to the following pattern: the difference which is present between the actual value and the setpoint value for the yaw velocity is converted into said setpoint values. If an oversteering driving behavior of the vehicle is to be compensated, the setpoint values for the wheel contact forces have to be predefined in such a way that the resulting wheel load at the rear axle is greater than the resulting wheel load at the front axle. If an understeering driving behavior of the vehicle is to be compensated, the setpoint values for the wheel contact forces have to be predefined in such a way that the resulting wheel load at the front axle is greater than the resulting wheel load at the rear axle.

As is apparent from FIG. 4, an exchange occurs between the blocks 403 and 405. A first reason for this exchange is that it is to be possible to influence the setpoint value for the yaw velocity as a function of the change variable V or the diagonal tensioning of the chassis which is present or performed. For this purpose, when diagonal tensioning of the chassis is present, the change variable V has a value which is different from zero and it is determined whether an oversteering or an understeering driving behavior of the vehicle is present. In the case of an oversteering driving behavior, the setpoint value for the yaw velocity is increased. In the case of an understeering driving behavior, the setpoint value for the yaw velocity is reduced. The correction of the setpoint value for the yaw velocity is performed for the following reason or is necessary for the following reason: the diagonal tensioning of the chassis and the associated influencing of the steering behavior of the vehicle lead to the driving behavior of the vehicle being influenced, and this is not taken into account in the determination of the setpoint value for the yaw velocity as a function of the velocity of the vehicle and the steering angle—the diagonal tensioning of the chassis which is performed is not sensed by means of the velocity of the vehicle or by means of the steering angle. As a result, when there is an uncorrected setpoint value for the yaw velocity in the case of diagonal tensioning of the chassis, there would be a difference between the actual value and the setpoint value for the yaw velocity, which would be detected by the yaw velocity controller 403 and would lead to the vehicle movement dynamics controller 401 carrying out stabilizing interventions in terms of closed-loop control on the yaw velocity. These interventions which are carried out by the vehicle movement dynamics controller 401 would counteract the influencing of the driving behavior of the vehicle brought about by means of the diagonal tensioning of the chassis, i.e. would finally cancel out said influencing, and overall the driving behavior of the vehicle would therefore remain uninfluenced. If the diagonal tensioning of the chassis is intended to bring about a better steering-in behavior of the vehicle, if the setpoint value of the yaw velocity were not corrected, the actual value would be higher in absolute terms than the setpoint value and the yaw velocity controller 403 would detect an oversteering driving behavior of the vehicle, for which reason the vehicle movement dynamics controller 401 would carry out braking interventions which would cancel out this supposed oversteering driving behavior. Since this oversteering driving behavior of the vehicle resulting from the diagonal tensioning of the chassis is desired, the setpoint value for the yaw velocity is correspondingly increased, and the yaw velocity controller 403 therefore detects a neutral driving behavior of the vehicle and stabilizing braking interventions are not carried out—the driving behavior of the vehicle which is to be brought about by the diagonal tensioning of the chassis can therefore be set. Whether an oversteering or an understeering driving behavior of the vehicle is present can be determined in the yaw velocity controller 403 by reference to a difference between the actual value and the setpoint value of the yaw velocity. If the actual value is higher than the setpoint value, oversteering is present. If the actual value is lower than the setpoint value, understeering is present.

A second reason for this exchange is that it is to be possible to use the yaw velocity controller 403 to influence the determination, occurring in the block 405, of the wheel load distribution, or to influence the determination, occurring in the block 405, of the change variable V. This possibility of exerting influence may be necessary, for example, for the following reason: the inventive diagonal tensioning of the chassis leads, during cornering, to a desired oversteering driving behavior of the vehicle. As long as this oversteering varies within certain limits, it is felt to be positive by the driver since the vehicle behaves in a more agile way and exhibits a more pronounced degree of cornering-friendliness. However, if this oversteering exceeds certain limits, the driver no longer feels this to be pleasant. In this case, the value of the change variable V which is determined in the block 405 is reduced or the change variable V which is determined in the block 405 can be replaced by a change variable determined in the block 403. The influencing of the block 405 by means of the yaw velocity controller 403 described above is significant in particular for a case in which the yaw velocity controller 403 does not output any setpoint values Fnsollij for the wheel contact forces. Excessive oversteering can be detected by the yaw velocity controller 403 by evaluating the difference between the actual values and the setpoint value of the yaw velocity. Oversteering is present if the actual value is higher than the setpoint value. If this difference is greater than a predefined threshold value, the yaw velocity controller 403 takes corresponding measures according to the statements above.

In addition, according to FIG. 4 an exchange occurs between the blocks 401 and 405. For example the following variables can therefore be fed to the block 405 from the block 401: a traction control system flag, which indicates that actuator-driving variables or open-loop control signals for carrying out stabilizing interventions for performing closed-loop control on the traction are output by the vehicle movement dynamics controller 401. The traction control system flag therefore indicates that the vehicle movement dynamics controller 401 is active in accordance with the functionality of a traction controller. A flag indicates that braking is occurring on a bend. This flag is generated when, for example, the cornering variable has a value which is different from zero and at the same time the brake pedal is actuated, i.e. braking is being carried out by the driver, or a braking intervention is being carried out independently of the driver. A flag which indicates that what is referred to as μ-split braking is present, that is to say braking is being performed by the driver while the vehicle is moving on a roadway which has different coefficients of friction for the left-hand and right-hand sides of the vehicle.

The exporting of the determination of the change variable V into a separate block 405 has the advantage that the diagonal tensioning of the chassis can be defined without having to perform fundamental changes to existing controllers such as, for example, the yaw velocity controller 403, the vehicle movement dynamics controller 401 or the ride control system 407.

In FIG. 4 this is not illustrated for reasons of clarity but the actuators 408ij and 409ij are the actuators which are denoted by 303ij in FIG. 3.

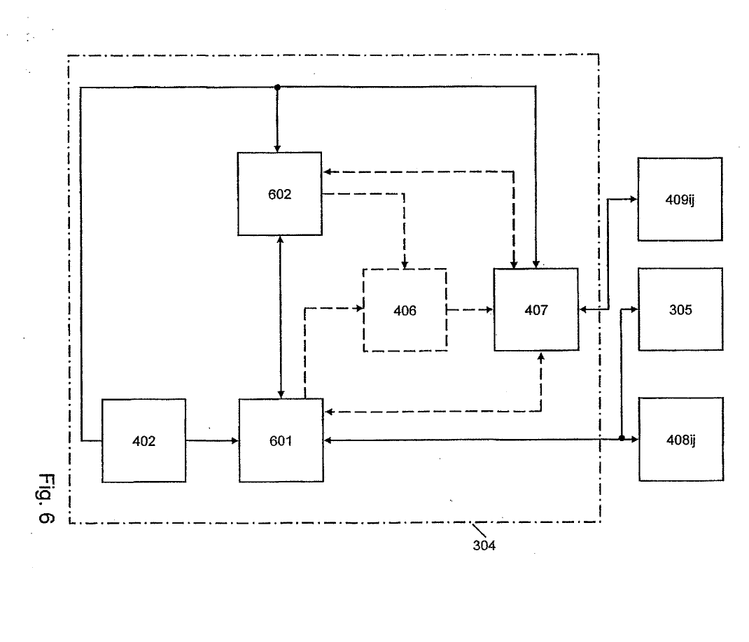

FIG. 5 shows the design of the open-loop control device 304 according to the invention in accordance with a second embodiment. In this second embodiment, the two separate blocks 401 and 403 which are contained in FIG. 4, that is to say the yaw velocity controller and the vehicle movement dynamics controller, are combined to form one functional unit 501. As a result of this, the variables which are fed to the two blocks 401 and 403 from the block 402 in accordance with FIG. 4 are fed from the block 402 to the block 501. In addition, the exchange which takes place between the two blocks 405 and 501 comprises the exchange which, according to FIG. 4, takes place on the one hand between the two blocks 403 and 405 and on the other between the two blocks 401 and 405. Furthermore, the variables which, according to FIG. 4, are fed from the block 401 to the block 406 and from the block 403 to the block 406 are fed from the block 501 to the block 406. The blocks 402, 404, 405, 406, 407, 408ij, 305 and 409ij which are contained in FIG. 5 correspond to those which are illustrated in FIG. 4. Accordingly, as is apparent from the description of FIG. 4, the variables are also fed to these blocks which are illustrated in FIG. 5, and/or these blocks which are illustrated in FIG. 5 also output the variables such as is apparent from the description of FIG. 4.

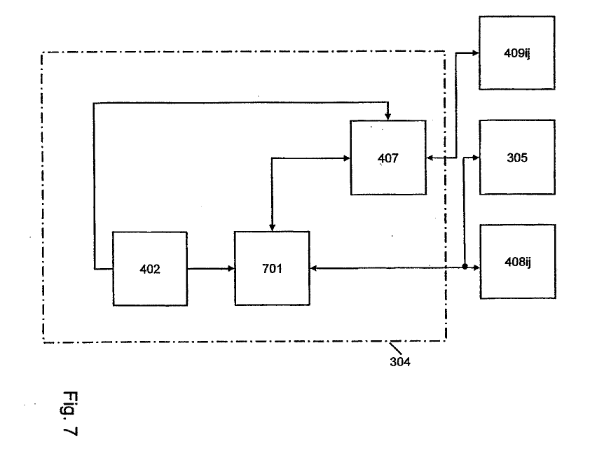

FIG. 6 shows the design of the open-loop control device 304 according to the invention in accordance with a third embodiment. In this embodiment, the yaw velocity controller 602 and the vehicle movement dynamics controller 601 are embodied as separate functional units, as is the case in accordance with the embodiment illustrated in FIG. 4. In contrast to the embodiment illustrated in FIG. 4, in the embodiment illustrated in FIG. 6 the function of the block 405—and with it also the function of the block 404—is integrated into the yaw velocity controller 602 or into the vehicle movement dynamics controller 601.

The two refinements which are specified above will be considered separately below. In the first refinement in which both the function of the block 404 and the function of the block 405 are integrated into the yaw velocity controller 602, the variables which, according to FIG. 4, are fed from the block 402 to the two blocks 403 and 404 are fed to the block 602. As far as the exchange between the two blocks 601 and 602 is concerned, this exchange comprises the exchange which, according to FIG. 4, takes place on the one hand between the blocks 401 and 403 and on the other between the two blocks 401 and 405. The variables which, according to the description of FIG. 4, are fed from the block 402 to the block 401 are fed from the block 402 to the block 601. The setpoint values Fnsollij which are determined in the block 602 for the wheel contact forces are fed to the ride control system 407. In this alternative, it is assumed that the block 601 does not determine any setpoint values Fnsollij for the wheel contact forces. According to a second alternative, the block 601 also determines setpoint values Fnsollij for the wheel contact forces. In this case, the respectively determined setpoint values are not fed directly to the ride control system 407 but rather to the block 406 in which the setpoint values are combined to form a uniform setpoint value, as is apparent from the description of FIG. 4. These two conceivable alternatives are indicated in FIG. 6 by means of the dot-dash representation.

In the second refinement in which both the function of the block 404 and the function of the block 405 are integrated into the vehicle movement dynamics controller 601, the variables which, according to FIG. 4, are fed from the block 402 to the two blocks 401 and 404 are fed to the block 601. As far as the exchange between the two blocks 601 and 602 is concerned, this exchange comprises the exchange which, according to FIG. 4, takes place on the one hand between the blocks 401 and 403 and on the other between the two blocks 403 and 405. The variables which, according to the description of FIG. 4, are fed from the block 402 to the block 403 are fed from the block 402 to the block 602. The setpoint values Fnsollij which are determined in the block 601 for the wheel contact forces are fed to the ride control system 407. In this alternative, it is assumed that the block 602 does not determine any setpoint values Fnsollij for the wheel contact forces. According to a second alternative, the block 602 also determines setpoint values Fnsollij for the wheel contact forces. In this case, the respectively determined setpoint values are not fed directly to the ride control system 407 but rather to the block 406 in which the setpoint values are combined to form a uniform setpoint value, as is apparent from the description of FIG. 4.

The blocks 402, 406, 407, 408ij, 305 and 409ij which are contained in FIG. 6 correspond to those which are illustrated in FIG. 4. Accordingly, as is apparent from the description of FIG. 4, the variables are also fed to these blocks illustrated in FIG. 6 and/or these blocks which are illustrated in FIG. 6 also output the variables, as is apparent from the description of FIG. 4.

FIG. 7 shows the design of the open-loop control device 304 according to the invention in accordance with a fourth embodiment. In this fourth embodiment, the two separate blocks 401 and 403 which are contained in FIG. 4, that is to say the yaw velocity controller and the vehicle movement dynamics controller, are combined to form one functional unit 701 into which the functions of the blocks 404 and 405 which are illustrated in FIG. 4 are additionally integrated. The variables which, according to FIG. 4, are fed from the block 402 to the blocks 401, 403 and 404 are fed from the block 402 to the block 701. The setpoint values Fnsollij which are determined in the block 701 for the wheel contact forces are fed to the ride control system 407. The blocks 402, 407, 408ij, 305 and 409ij which are contained in FIG. 7 correspond to those which are illustrated in FIG. 4. Accordingly, as is apparent from the description of FIG. 4, the variables are also fed to these blocks illustrated in FIG. 7 and/or these blocks which are illustrated in FIG. 7 also output the variables, as is apparent from the description of FIG. 4.

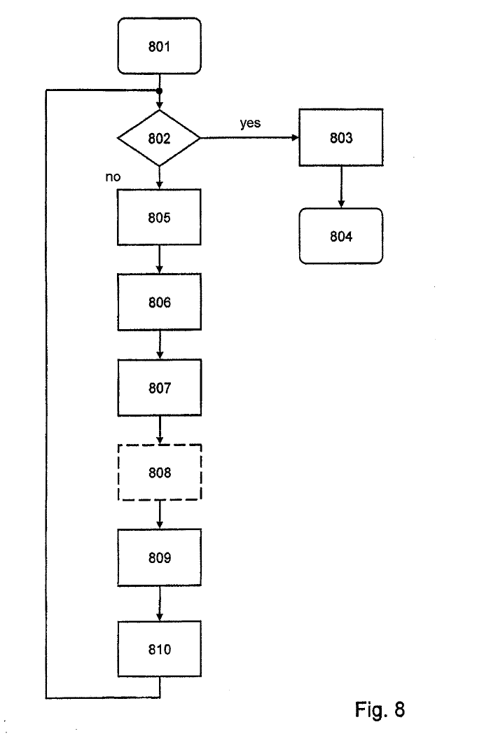

FIG. 8 is a flow chart illustrating the sequence of the method according to the invention which runs in the device according to the invention.

The method according to the invention starts with a step 801 which is followed by a step 802. In this step 802 it is checked whether an abort criterion is met. For this purpose it is possible to check whether, for example, a fault occurs in one of the controllers, i.e. the yaw velocity controller or the vehicle movement dynamics controller or the ride control system, or whether a fault occurs at another component which is involved. If it is detected in the step that the abort criterion is met, a step 803 is subsequently carried out and the method according to the invention is then ended with a step 904. In the step 803, at least the actuators 409ij which are assigned to the individual vehicle wheels 302ij and with which the wheel contact force Fnij occurring at the respective vehicle wheel 302ij can be influenced on a wheel-specific basis are placed in a defined state.

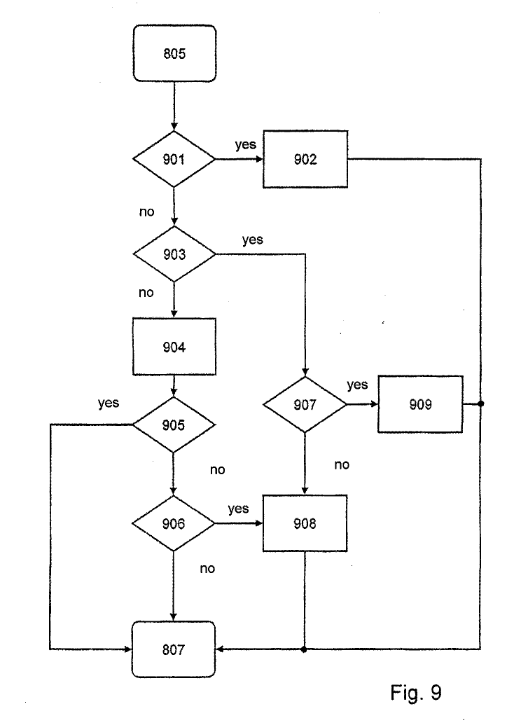

In contrast, if it is detected in the step 802 that the abort criterion is not met, a step 805 is carried out after the step 802. In the step 805, different variables which are required for the determination of the change variable V are made available and these include the cornering variable which is a variable which describes the lateral acceleration, and the derivative of the cornering variable over time. In a step 806 which follows the step 805, a value for the change variable V is determined. Details on the specific procedure here will be given in conjunction with FIG. 9. The step 806 is followed by a step 807 in which setpoint values Fnsollij for the wheel contact forces are determined as a function of the value of the change variable. If setpoint values Fnsollij for the wheel contact forces are determined by a plurality of controllers contained in the vehicle, said setpoint values Fnsollij are combined in a step 808 following the step 807 to form a setpoint value which is uniform for the respective vehicle wheels 302ij. A step 809 is carried out after the step 808. The step 808 is necessary only if setpoint values Fnsollij for the wheel contact forces are determined by various controllers contained in the vehicle. If such setpoint values are determined by only one controller, it is not necessary to carry out the step 808. In this case, the step 807 is followed directly by the step 809. The optional execution of the step 808 described above is indicated in FIG. 8 by the dot-dash representation. In the step 809, the setpoint values Fnsollij which are determined for the individual vehicle wheels 302ij and for the wheel contact forces which are to be set are converted in setpoint values for the adjustment travel or hydraulic pressure which is to be set at the respective actuator 409ij. In a step 810 which follows the step 809, the requested wheel contact forces at the individual vehicle wheels 302ij are set by influencing or setting the adjustment travel or the hydraulic pressure by correspondingly driving the actuators 409ij. The step 802 is carried out again after the step 810.

FIG. 9 illustrates the determination of the change variable which takes place in the step 806 or the routine for determining the change variable which occurs in the step 806. This routine follows the step 805, and said step 805 is followed by a step 901. In the step 901, it is checked whether the value of the cornering variable ay is lower than a first threshold value ay1. If the value of the cornering variable ay is lower than the first threshold value ay1, the chassis is not tensioned diagonally, for which reason subsequent to the step 901a step 902 is carried out in which the change variable V is assigned a first value V1. The step 902 is followed by the step 807, via which the routine for determining the change variable is exited.

On the other hand, if it is detected in the step 901 that the value of the cornering variable ay is higher than the first threshold value ay1, the chassis is tensioned diagonally, for which reason a step 903 is carried out after the step 901. By means of the step 903 it is firstly checked whether a flag is set which indicates that diagonal tensioning of the chassis has already been carried out in accordance with the modified functional relationship. If the flag is not set, a step 904 is carried out after the step 903. In the step 904, a value for the change variable V is determined in accordance with the functional relationship as a function of the value of the cornering variable ay. That is to say diagonal tensioning of the chassis is carried out in accordance with the functional relationship. The step 904 is followed by a step 905. In the step 905 it is checked whether the value of the cornering variable ay is less than a second threshold value ays. At this second threshold value, the profile of the functional relationship has its apex or its absolute maximum. If it is detected in the step 905 that the value of the cornering variable ay is less than the second threshold value ays, there is no need to modify the functional relationship, for which reason the step 905 is followed by the step 807. In contrast, if it is detected in the step 905 that the value of the cornering variable ay is higher than the second threshold value ays, a step 906 is carried out after the step 905. In the step 906 it is determined whether the driver steers back out of the bend or whether the driver turns back the steering wheel, i.e. whether a bend exiting process or a steering back process or a direction changing process is present or whether the direction changing point is reached. This can be detected, for example, by evaluating the derivation of the cornering variable over time or by evaluating the derivation of the absolute value of the cornering variable over time. If a negative value is detected for the derivation over time, a direction changing process is occurring and the driver is steering back out of the bend, for which reason it is necessary to modify the functional relationship. For this reason, a step 908 is carried out after the step 906 if a negative derivative for the cornering variable is present. In the step 908, on the one hand the flag is set which indicates that diagonal tensioning of the chassis is being carried out in accordance with the modified functional relationship. On the other hand, in the step 908 the modified functional relationship is used to determine a value for a modified change variable Vm as a function of the value of the cornering variable ay. That is to say diagonal tensioning of the chassis is carried out in accordance with the modified functional relationship. Subsequent to the step 908, the step 807 is carried out. In contrast, if in the step 906 is determined that the driver is not yet steering back out of the bend, i.e. that the direction changing point is not yet reached, it is also not necessary to carry out the diagonal tensioning of the chassis in accordance with the modified functional relationship. In this case, subsequent to the step 906 the step 807 is carried out. In contrast, if in the step 903 it is detected that said flag is already set, i.e. that diagonal tensioning of the chassis is already being carried out in accordance with the modified functional relationship, a step 907 is carried out after the step 903. In the step 907 it is tested whether the value of the modified change variable which is determined using the modified functional relationship corresponds to the value of the change variable which is determined using the functional relationship for the same value of the cornering variable for which the value of the modified change variable was determined. If the two values do not correspond, the step 908 is carried out after the step 907. Diagonal tensioning of the chassis is also carried out in accordance with the modified functional relationship. In contrast, if it is detected in the step 907 that the two values correspond, a step 909 is carried out subsequent to the step 907. Since diagonal tensioning of the chassis in accordance with the modified functional relationship is now no longer necessary, said flag is deleted in the step 909. The step 807 is carried out after the step 909.

In the procedure illustrated in FIG. 9, the two steps 905 and 906 are used to detect when a predetermined driving state or operating state of the vehicle is present or is reached.

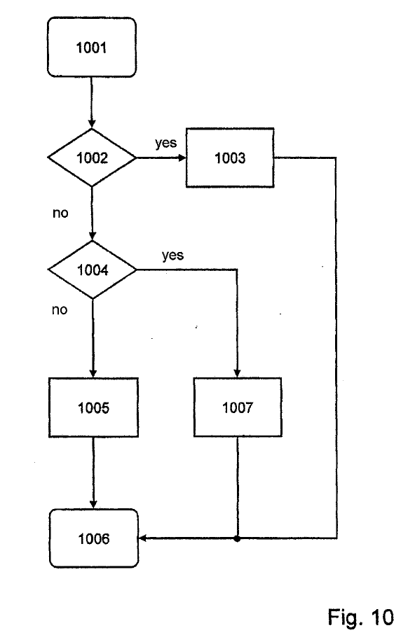

FIG. 10 illustrates the procedure for the diagonal tensioning of the chassis when predetermined driving states or operating states of the vehicle are present. The predetermined driving states or operating states which are under consideration are concerned, on the one hand, with cornering during which closed-loop control on the traction is carried out at least one driven wheel. On the other hand, said states are concerned with cornering during which a braking intervention is carried out at least one vehicle wheel.

The method starts with a step 1001 which is followed by a step 1002. In the step 1002 it is checked whether the value of the cornering variable ay is lower than a first threshold value ay1. If the value of the cornering variable ay is less than the first threshold value ay1, the chassis is not tensioned diagonally, for which reason subsequent to the step 1002 a step 1003 is carried out in which the change variable V is assigned a first value V1. The step 1003 is followed by a step 1006 with which the method is ended.

In contrast, if it is detected in the step 1002 that the value of the cornering variable ay is higher than the first threshold value ay1, diagonal tensioning of the chassis is carried out, for which reason a step 1004 is carried out after the step 1002. In the step 1004, it is tested whether a flag is set which indicates the execution of closed-loop control on the traction at least one vehicle wheel, or whether a flag is set which indicates activation of the brake pedal by the driver and therefore the execution of a braking process independent of the driver. If no such flag is present, there is also no need to carry out diagonal tensioning of the chassis in accordance with a modified functional relationship. In this case, after the step 1004 a step 1005 is carried out with which measures for carrying out diagonal tensioning of the chassis in accordance with the functional relationship are carried out. After the step 1005, a step 1006 is carried out with which the method is ended. In contrast, if it is detected in the step 1004 that one of the flags referred to above is set, it is necessary to carry out diagonal tensioning of the chassis in accordance with a modified functional relationship. For this reason, after the step 1004 a step 1007 is carried out. If it is detected in the step 1004, by evaluating the flags, that closed-loop control on the traction is carried out at least one driven wheel during cornering, a functional relationship which is adapted specifically to this driving situation is selected and the diagonal tensioning of the chassis is carried out in accordance with this relationship. According to the modified functional relationship, the tensioning is eliminated, i.e. cancelled out or else reduced at the driven wheel at which closed-loop control is performed on the traction. For this purpose, corresponding setpoint values for the wheel contact force which is to be set at this driven wheel are determined. The elimination of the tensioning can be carried out, for example, by means of a time ramp. If it is detected in the step 1004, by evaluating the flags, that a braking intervention is carried out during cornering, a functional relationship which is specifically adapted to this driving situation is selected and the diagonal tensioning of the chassis is carried out in accordance with this relationship. According to the modified functional relationship, the tensioning is reduced or eliminated. This may be the case for individual vehicle wheels or else for all the vehicle wheels. After the step 1007 a step 1006 is carried out.

FIG. 10 is intended merely to illustrate a theoretical procedure. Of course, the procedure illustrated in FIG. 10 can also be integrated into the method described on the basis of the two FIGS. 8 and 9 or can be combined with this method.

A further aspect will be considered below. This is what is referred to as μ-split braking. μ-split braking is a braking process which is carried out by the driver and during which the vehicle travels on a roadway which has different coefficients of friction for the left-hand and right-hand sides of the vehicle. During such a braking process, different braking forces occur at the left-hand and right-hand vehicle wheels and said forces cause the vehicle to rotate about its vertical axis, specifically in the direction of the side of the roadway which has the higher coefficient of friction. If the vehicle is equipped with an active suspension system, diagonal tensioning of the chassis may be carried out when μ-split braking is present, in order to counteract the rotational movement, at least at the beginning. During the diagonal tensioning of the chassis when μ-split braking occurs the procedure adopted is as follows: at first the wheel contact force at the front vehicle wheel which is located on the side of the roadway with the higher coefficient of friction is increased in order to counteract the rotation of the vehicle about its vertical axis by means of the toe-in of the vehicle wheel. At the same time, owing to the diagonal tensioning at the rear vehicle wheel, which is on the side of the roadway with the lower coefficient of friction, the wheel contact force is also increased. Since the diagonal tensioning simultaneously relieves the loading on the rear wheel which is important for the directional stability and which is located on the side of the roadway with the higher coefficient of friction, this diagonal tensioning can be maintained only at the start of the braking process. After a certain period, the wheel contact force at the rear vehicle wheel which is on the side of the roadway with the higher coefficient of friction is therefore increased. The chassis is also diagonally tensioned at the same time.

The diagonal tensioning of the chassis which is described here and which has the purpose of compensating the rotational movement of the vehicle about its vertical axis which occurs during μ-split braking does not necessarily have to have or comprise all the secondary technical aspects which have been described above in conjunction with FIGS. 1 to 10. Provided that it is technically appropriate, for example because corresponding secondary technical aspects can be used or constitute an advantageous development, it is to be possible to combine the diagonal tensioning of the chassis which is described here and which has the purpose of compensating the rotational movement of the vehicle about its vertical axis with these actual secondary technical aspects in any desired way.

Since the diagonal tensioning of the chassis which is described here and which has the purpose of compensating the rotational movement of the vehicle about its vertical axis is an independent technical subject matter which is not necessarily linked with the secondary technical aspects which have been described in conjunction with FIGS. 1 to 10, the applicant reserves the right to direct a separate application at this technical subject matter. The secondary technical aspects which give rise to an appropriate supplement or development can then be incorporated in this application. The same also applies correspondingly to the driving state of cornering during which closed-loop control is performed on the traction at least one driven wheel, or to the driving state of cornering during which braking is carried out.

In particular, in the two last-mentioned driving states it is also conceivable that the driving behavior of the vehicle can be influenced by correspondingly influencing the wheel contact forces present at the vehicle wheels even when there is no previously set diagonal tensioning of the chassis. It will also be possible to pursue these aspects in a separate application. The respectively indicated matters above for which protection is sought and for which separate patent applications are conceivable will each be capable of being combined with any technical aspects contained in the present application.

A number of considerations will now be mentioned. Instead of predefining setpoint values for the wheel contact forces it is also possible to predefine setpoint values for the changes in wheel contact forces.

In terms of the driving situation during which closed-loop control is performed on the traction at least one driven wheel during cornering, it is to be noted that the block 402 does not necessarily have to be embodied as a vehicle movement dynamics controller. It would also be sufficient if the block 402 alone were to have the functionality of a traction controller.

Exporting the determination of the change variable V into a separate block 405 has the advantage that the diagonal tensioning of the chassis can be defined without fundamental changes having to be made to existing controllers such as, for example, the yaw velocity controller 403, the vehicle movement dynamics controller 401 or the ride control system 407.

μ-split braking can be detected, for example, by reference to the profiles of the brake pressures of the left-hand and right-hand vehicle wheels. μ-split braking can also be detected by virtue of the fact that the vehicle performs a rotational movement about its vertical axis without the driver activating the steering wheel and by the fact that at the same time a signal is present which represents activation of the brake pedal by the driver.

1-32. (canceled)

33. A system for influencing driving behavior of a vehicle comprising:
first closed-loop control means for performing closed-loop control on a variable that describes a yaw velocity, and
second closed-loop control means for influencing wheel contact forces occurring at vehicle wheels,
wherein the first and second closed-loop control means interact so that, at at least one of the first and second closed-loop control means, a variable, which is included in the respective closed-loop control, is influenced as a function of a variable of the other of the first and second closed-loop control means.

34. The system as claimed in claim 33, wherein, at the first closed-loop control means, a setpoint value for the yaw velocity is influenced as a function of a variable, which is generated in the second closed-loop control means and which represents the influencing of the wheel contact forces that is to be carried out by the second closed-loop control means.

35. The system as claimed in claim 33, wherein, at the second closed-loop control means, a variable which represents the influencing of the wheel contact forces that is to be carried out by the second closed-loop control means is influenced as a function of a difference variable which is determined in the first closed-loop control means and which represents a difference which is present between an actual value and the setpoint value of the yaw velocity.

36. The system as claimed in claim 33, wherein a cornering variable that represents the presence of cornering of the vehicle is determined, and wherein, at least one vehicle wheel, a wheel contact force is influenced in accordance with a functional relationship as a function of the cornering variable, wherein, when a predetermined driving state or operating state of the vehicle is present or is reached, the functional relationship is modified, and wherein the influencing of the wheel contact force is carried out in accordance with the modified functional relationship as a function of the cornering variable.

37. The system as claimed in claim 36, wherein the cornering variable is a variable which describes the lateral acceleration.

38. The system as claimed in claim 37, wherein the variable which describes the lateral acceleration is measured by way of a lateral acceleration sensor or is determined as a function of a variable that describes the steering angle and a variable that describes the velocity of the vehicle.

39. The system as claimed in claim 36, wherein the vehicle has a left-hand front wheel and a right-hand front wheel as well as a left-hand rear wheel and a right-hand rear wheel, wherein in each case a front wheel and a rear wheel are assigned to one of the two vehicle diagonals, wherein, for at least one of the two vehicle diagonals, the wheel contact forces at the two vehicle wheels are influenced in accordance with the functional relationship as a function of the cornering variable, and wherein the wheel contact forces at these two vehicle wheels are changed in the same way.

40. The system as claimed in claim 39, wherein the individual vehicle wheels are respectively assigned actuators for wheel-specific influencing of the wheel contact force occurring at the respective vehicle wheel, and wherein the wheel contact forces at the two vehicle wheels of the at least one vehicle diagonal are changed in the same way by virtue of the fact that the actuators of these two vehicle wheels are driven in a corresponding way, or
by virtue of the fact that the actuators of those vehicle wheels which are assigned to the other vehicle diagonal are driven in a complementary way, or
by virtue of the fact that the actuators of those vehicle wheels which are assigned to the at least one vehicle diagonal and the actuators of those vehicle wheels which are assigned to the other vehicle diagonal are driven in opposing ways.

41. The system as claimed in claim 36, wherein, when cornering, the vehicle has a front wheel on the outside of the bend, a front wheel on the inside of the bend, a rear wheel on the outside of the bend, and a rear wheel on the inside of the bend, wherein, in each case, a front wheel and a rear wheel are assigned to one of the two vehicle diagonals, wherein, for at least one of the two vehicle diagonals, the wheel contact forces at the two vehicle wheels are influenced in accordance with the functional relationship as a function of the cornering variable, wherein the respective wheel contact force is decreased both at the front wheel on the outside of the bend and at the rear wheel on the inside of the bend, and wherein the respective wheel contact force is increased both at the front wheel on the inside of the bend and at the rear wheel on the outside of the bend.

42. The system as claimed in claim 41, wherein the individual vehicle wheels are respectively assigned actuators for wheel-specific influencing of the wheel contact force occurring at the respective vehicle wheel, wherein the actuators which are respectively assigned to the front wheel on the outside of the bend and the actuators which are respectively assigned to the rear wheel on the inside of the bend are driven in such a way that the respective wheel contact force is decreased at these two vehicle wheels, and wherein the actuators which are respectively assigned to the front wheel on the inside of the bend and the actuators which are respectively assigned to the rear wheel on the outside of the bend are driven in such a way that the respective wheel contact force is increased at these two vehicle wheels.

43. The system as claimed in claim 41, wherein the wheel contact forces are increased, decreased, or increased and decreased by the same absolute value.

44. The system as claimed in claim 36, wherein the functional relationship as a function of the cornering variable is used to determine a change variable, which is a measure of the change in the wheel contact force which is to be carried out.

45. The system as claimed in claim 44, wherein the change variable is the value by which the wheel contact force is to be changed.

46. The system as claimed in claim 44, wherein a setpoint value is determined for the wheel contact force that is to be set on the basis of the change variable and an actual value, which is determined for the wheel contact force.

47. The system as claimed in claim 46, wherein the vehicle wheel is assigned an actuator for wheel-specific influencing of the wheel contact force occurring at this vehicle wheel, and wherein a predefined value for the driving of the actuator is determined as a function of the setpoint value for the wheel contact force which is to be set.

48. The system as claimed in claim 47, wherein the predefined value is a setpoint value for a travel variable which is to be set with the actuator or a setpoint value for a pressure variable which is to be set at the actuator.

49. The system as claimed in claim 44, wherein the functional relationship is divided into a plurality of sections, wherein, in a first section for which the cornering variable is lower than a first threshold value, the change variable assumes a first value which essentially corresponds to the value zero, wherein, in a second section for which the cornering variable is higher than the first threshold value and lower than a second threshold value, the value of the change variable increases starting from the first value to a second value, wherein, in a third section for which the cornering variable is higher than the second threshold value and lower than a third threshold value, the value of the change variable decreases starting from the second value to a third value, and wherein, in a fourth section for which the cornering variable is higher than the third threshold value, the value of the change variable essentially retains the third value.

50. The system as claimed in claim 36, wherein the predetermined driving state or operating state of the vehicle is reached or is present when the cornering variable is higher than a threshold value and at the same time a decrease in the cornering variable over time or in another vehicle variable which also represents cornering is detected.

51. The system as claimed in claim 50, wherein the threshold value for the cornering variable is the value of the cornering variable at which the change variable has its absolute maximum in accordance with the functional relationship.

52. The system as claimed in claim 44, wherein the modified functional relationship as a function of the cornering variable is used to determine a modified change variable which is a measure of the change in the wheel contact force which is to be carried out, wherein the respective value of the modified change variable does not exceed, or only exceeds to an insignificant degree, the value of the change variable which was determined using the functional relationship when the predetermined driving state or operating state of the vehicle started or was present.

53. The system as claimed in claim 52, wherein the value of the change variable which was determined using the functional relationship when the predetermined driving state or operating state of the vehicle started or was present is retained as the value of the modified change variable, or wherein the respectively determined value of the modified change variable is lower in absolute terms than said value of the change variable.

54. The system as claimed in claim 52, wherein the modified change variable is determined using the modified functional relationship until the value of the modified change variable corresponds to a value of the change variable which has been determined using the functional relationship and which is determined for a value of the cornering variable which is lower than the value of the cornering variable which was present when the predetermined driving state or operating state of the vehicle started or was present.

55. The system as claimed in claim 53, wherein the modified functional relationship is a functional relationship which has a monotonously falling profile toward lower values of the cornering variable with respect to the value of the cornering variable and the value of the change variable which was determined for it, both values being present when the predetermined driving state or operating state of the vehicle started or was present.

56. The system as claimed in claim 55, wherein said system comprises a linear function with a negative gradient.

57. The system as claimed in claim 56, wherein the value of the gradient is permanently predefined, or is determined as a function of the value of the change variable which was present when the predetermined driving state or operating state of the vehicle started or was present.

58. The system as claimed in claim 53, wherein the predetermined driving state or operating state of the vehicle is reached or is present when a traction control system which is arranged in the vehicle at least one driven wheel carries out interventions for performing closed-loop control on the traction present at this driven wheel during cornering.

59. The system as claimed in claim 58, wherein the value of the modified change variable is determined from the value of the change variable which was determined using the functional relationship and which was present when the predetermined driving state or operating state of the vehicle started or was present is reduced by a permanently predefined value or by a value which is determined as a function of said value of the change variable, or the value of the change variable which was determined using the functional relationship and which was present when the predetermined driving state or operating state of the vehicle started or was present is reduced until intervention for performing closed-loop control on the traction no longer occurs at the at least one driven wheel.

60. The system as claimed in claim 58, wherein the wheel contact force is set in accordance with the modified change variable at least at the at least one driven wheel at which closed-loop control on the traction is carried out.

61. The system as claimed in claim 53, wherein the predetermined driving state or operating state of the vehicle is reached or is present when a braking intervention is carried out during cornering.

62. The system as claimed in claim 61, wherein the value of the modified change variable is determined as follows: the value of the change variable which was determined using the functional relationship and which was present when the predetermined driving state or operating state of the vehicle started or was present is reduced by a permanently predefined value or by a value which is determined as a function of said value of the change variable.

63. A system for influencing driving behavior of a vehicle comprising:
determining means for determining a cornering variable which represents the presence of cornering of the vehicle, and
influencing means with which, at least one vehicle wheel, the wheel contact force is influenced in accordance with a functional relationship as a function of the cornering variable,
wherein, when a predetermined driving state or operating state of the vehicle is present or is reached, the functional relationship is modified, and influencing of the wheel contact force is carried out in accordance with the modified functional relationship as a function of the cornering variable.

64. A system for influencing driving behavior of a vehicle comprising brakes and a chassis, wherein a presence of braking on a roadway is sensed with different coefficients of friction for two sides of the vehicle so that, when braking is present, the chassis is tensioned diagonally at least for a certain time.
